(19) United States
(12) Patent Application Publication
(10) Pub. No.: US 2007/0081328 A1
(43) Pub. Date: Apr. 12, 2007

(54) Illuminating device for plants

(76) Inventor: Chi-Chin Yu, Taipei (TW)

Correspondence Address: BACON & THOMAS, PLLC, 625 SLATERS LANE, FOURTH FLOOR, ALEXANDRIA, VA, 22314, US

(21) Appl. No.: 11/203,091

(22) Filed: Aug. 15, 2005

(51) Int. Cl. B60Q 1/26

(52) U.S. Cl. 362/227

(57) ABSTRACT

An illuminating device has a board with multiple holes. Multiple domes are formed on a top side of the board and respectively located among the holes. An energy transferring film is coated on the top side of the board. Multiple light sources are respectively inserted into the holes and erected from the top side of the board. Therefore, lights emitted from the light sources can be refracted by the domes to irradiate plants at a desired direction. Exhaust heat of the light source and light rays projected on the board can be transferred to far infrared light rays with wavelength of 4-12 μm by the film to irradiate the plants again for promoting the growth of the plants.

### BACKGROUND OF THE INVENTION

1. Field of the Invention

The present invention relates to an illuminating device, and more particularly to the illuminating device which can transfer exhaust heat and light rays to a previously ineffective direction of light sources into far infrared rays to thereby promote growth of plants.

2. Description of Related Art

To grow vegetables and fruit well, planters can improve the condition of soils, varieties of the plants, the climate and use insecticides. Some vegetables and fruit grow quickly when they are irradiated by lights, so that the planter uses various illuminating devices such as fluorescent lamps, incandescent lamps, etc. suspended above the plants to promote the production of the plants.

However, the conventional illuminating devices do not use the energy and light fully, so their irradiating efficiency is low.

Therefore, the invention provides an illuminating device to mitigate or obviate the aforementioned problems.

### SUMMARY OF THE INVENTION

The main objective of the present invention is to provide an illuminating device which can transfer exhaust heat and light rays to an ineffective direction of light sources for irradiating plants thereby fully using the energy and light of the light sources.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an illuminating device for plants in accordance with the present invention;

FIG. 2 is an exploded perspective view of the illuminating device for plants in accordance with the present invention; and

FIG. 3 is a partially sectional view of the illuminating device for plants in accordance with the present invention.

### DETAILED DESCRIPTION OF THE PREFERRED EMBODIMENT

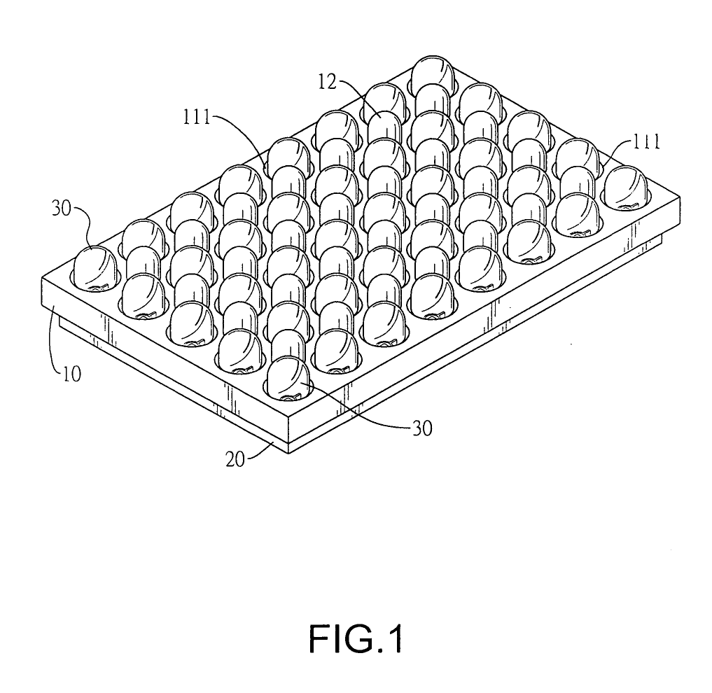

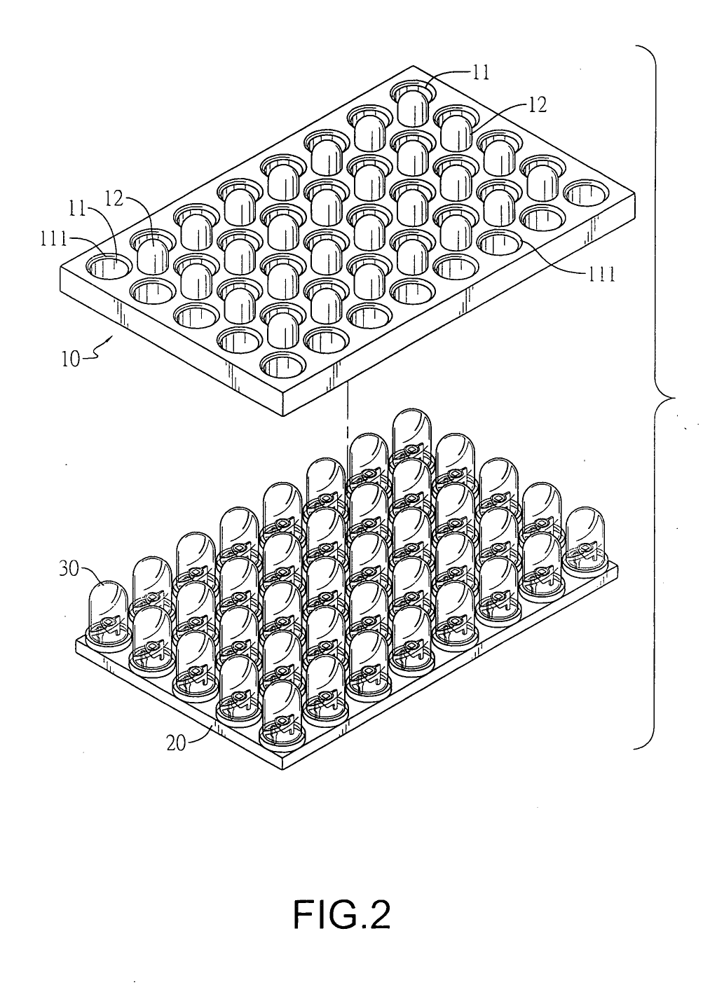

With reference to FIGS. 1 and 2, an illuminating device for plants in accordance with the present invention comprises a board (10), a base (20) which is mounted under the board (10), and multiple light sources (30).

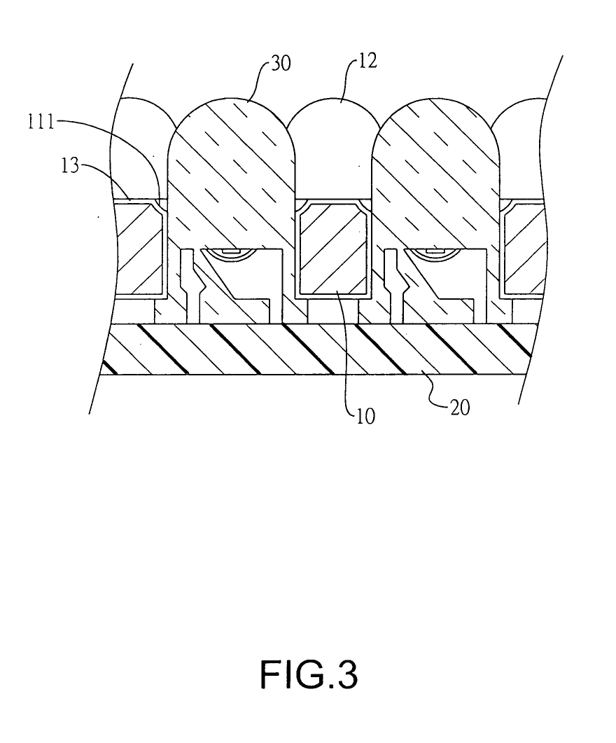

Multiple holes (11) are defined through the board (10). Multiple annular recesses (111) are respectively defined on top circumferences of the holes (11). Multiple domes (12), each with a hollow chamber, are integrally protruded from a top side of the board (10) and respectively located among the holes (11). Each dome (12) has a semispherical top end. As shown in FIG. 3, an energy transferring film (13), which can transfer light rays and heat into energy, is coated on the top side of the board (10). In a preferred embodiment of the present invention, the energy transferring film (13) is a ceramic film absorbing exhaust heat and light rays to regenerate far infrared light rays with wavelength of 4-12 μm.

With reference to FIG. 2, the light sources (30) are respectively inserted into the holes (11) and erected from the top side of the board (10). In the preferred embodiment of the present invention, each light source (30) is a bullet-like LED (Light Emitting Diode) of which an outer shell is composed of a semi-spherical head and a barrel-like body. The LEDs are mounted on the base (20) and in alignment with the holes (11) respectively.

With reference to FIG. 3, when the illuminating device is operating, light emitted from the barrel body of the LED is refracted by the dome (12) to a direction substantially perpendicular to the top side of the board (10). Hence, the light from the LED can effectively irradiate plants, such as vegetables or fruit, at a desired direction. Furthermore, the exhaust heat of the LEDs and the light projecting on the board (10) can be transferred to far infrared light rays with wavelength of 4-12 μm by the film (13) for promoting the growth of the plants. Therefore, the illuminating device has a high irradiating efficiency.

Moreover, electrical units such as current limiting resistors for the LEDs are respectively mounted in the domes (12), so that an inner wall of each nipple (12) can absorb the exhaust heat of the current limiting resistors thereby transferring to the light for promoting the growth of the vegetables and the fruit.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminating device comprising:
a board (10) having multiple holes (11) defined through the board (10), multiple domes (12) formed on a top side of the board and located among the holes (11), an energy transferring film (13), which can transfer light rays and heat into energy, coated on the top side of the board (10); and
multiple light sources (30) respectively inserted through the holes (11) and erected from the top side of the board (10) upwards.

2. The illuminating device as claimed in claim 1, wherein each dome (13) is integrally formed on the top side of the board (10) and a hollow chamber is defined in each dome (13).

3. The illuminating device as claimed in claim 1, wherein each hole (11) has an annular recess (111) defined at a top circumference of the hole (11).

4. The illuminating device as claimed in claim 2 further comprising a base (20) provided beneath the board (10), wherein the multiple light sources (30) are mounted on the base (20).

5. The illuminating device as claimed in claim 3, wherein the energy transferring film (13) is a ceramic film.

6. The illuminating device as claimed in claim 1, wherein each light source (30) is an LED.

7. The illuminating device as claimed in claim 6, wherein each LED (30) has a bullet-like shape.

8. The illuminating device as claimed in claim 7, wherein each dome (13) has a semispherical shape.
